(19) United States
(12) Patent Application Publication
(10) Pub. No.: US 2009/0053133 A1
(43) Pub. Date: Feb. 26, 2009

(54) Hydrogen generation through reactions involving sorption mechanisms

(75) Inventors: Alicja Zaluska, Montreal (CA); Leszek Zaluski, Montreal (CA)

Correspondence Address: KNOBBE MARTENS OLSON & BEAR LLP, 2040 MAIN STREET, FOURTEENTH FLOOR, IRVINE, CA, 92614, US

(73) Assignee: HER, HYDROGEN STORAGE SYSTEMS INC., Montreal (CA)

(21) Appl. No.: 12/064,006

(22) PCT Filed: Aug. 16, 2006
(86) PCT No.: PCT/CA2006/001338

§ 371 Date: Oct. 6, 2008

Related U.S. Application Data
(60) Provisional application No. 60/708,781, filed on Aug. 17, 2005.

(51) Int. Cl. C01B 3/02; C01B 3/06

(52) U.S. Cl. 423/648.1; 252/188.25

(57) ABSTRACT

A hydrogen generating composition, capable of liberating hydrogen through a sorption mechanism in the presence of vapour or gas of a reagent which comprises a sorbent compound for sorption of the vapour or gas of the reagent and a hydrogen-releasing agent for liberating hydrogen from the reagent retained by the sorbent compound.

### TECHNICAL FIELD

The present invention relates to hydrogen generation through reactions involving sorption mechanisms and more particularly, the present invention relates to hydrogen generation using a sorbent and a hydrogen releasing agent.

### BACKGROUND OF THE INVENTION

In the recent years, hydrogen technology is becoming an essential part of the renewable energy industry, where new energy carriers are expected to replace fossil fuels. The prospects for hydrogen to become a viable renewable energy carrier depend on efficient methods of generating, storing and controllably releasing hydrogen when needed.

Chemical storage of hydrogen is defined as a method of storing hydrogen in the form of chemical compounds containing hydrogen and liberating (generating) hydrogen through chemical reactions with suitable reagents.

A variety of potential reactions can be used to produce hydrogen (such as various types of hydrolysis reactions), which represent possible methods of chemical storage of hydrogen. Although on paper these methods appear to be relatively straightforward, application of chemical storage in hydrogen economy has been so far limited by numerous technical and practical difficulties. One major problem is related to the controllability and efficiency of the hydrogen generation reactions. Certain reactions can be very difficult to initiate and may require special catalysts to proceed. In other cases, the reaction starts instantly and is very difficult to stop or to control. Another common problem is related to incomplete reactions, being blocked by the formation of the reaction products. Engineering issues regarding start-up, turndown, and heat management are difficult to resolve. Amongst them, one of the most important problems is dosing of the reagent, which requires complicated instrumentation, such as mixers, stirrers, pumps and regulators.

One example of chemical storage reactions involves hydrolysis as a method of hydrogen generation from metals or hydrides. Hydrolysis produces hydrogen in reactions with water, following a generic formula:

M+H₂O→MOH+½H₂

(where M is a metal).

A typical example of such reactions is hydrolysis with alkali metals, where sodium or lithium readily react with water, according to the following reactions:

Na+H₂O→NaOH+½H₂

Li+H₂O→LiOH+½H₂

In practice these reactions are however uncontrollable and often violent. Once sodium is combined with water, the reaction proceeds very rapidly, until the whole sodium is consumed and transformed into the sodium hydroxide. This reaction is impossible to stop or interrupt and it generates large amounts of heat. Lithium behaves similarly, as well as other hydro-reactive metals.

On the other hand, a wide group of metals exists where reactions with water are prohibited because of their surface passivation which prevents hydrolysis. Examples of such metals include aluminum, magnesium, iron, copper, etc., as in the following reactions:

Mg+2H₂O→Mg(OH)₂+H₂

Al+3H₂O→Al(OH)₃+1½H₂

In such cases, hydrolysis in practice does not occur at all, since the oxide layer fully protects the metal from reacting with water.

Another group of hydrolysis reactions are reactions with hydrides instead of metals, and these reactions represent the most characteristic example of chemical storage technology. In this case, hydrolysis generates hydrogen according to the following generic reaction:

MH+H₂O→MOH+H₂

where M is a metal or metal compound capable of forming a hydride with hydrogen.

In these reactions, both the hydride and the reagent (water) contribute to the hydrogen generation in such a way that for each formed molecule of hydrogen one hydrogen atom is taken from the hydride and one from water.

In a similar way as with alkali metals, hydrolysis of hydrides is in practice often too rapid and vigorous, as in the case of such alkali metal hydrides as for instance LiH, LiAlH₄ or NaH. Combination of these hydrides with water is extremely unstable and they decompose almost explosively, so the reaction is in practice impossible to control. On the other hand, another group of hydrides (such as magnesium hydride, MgH₂, sodium borohydride, NaBH₄, or titanium hydride, TiH2) exhibit very high stability in water and hydrolysis practically does not proceed without heating water to hot, pressurized steam, or applying special catalysts.

Although reactions of hydrides with water are potentially very efficient in producing hydrogen (if the above drawbacks could be resolved), they have another significant limitation, the freezing point of water at 0° C. makes the use of hydrolysis difficult at lower temperatures. Therefore, in another type of hydrogen generation method, alcohols are used instead of water to release hydrogen form metals or hydrides. This has been set forth in European Patent No. 1284922B1. In particular, the use of mixtures of water with alcohols represents a practical solution to overcome the temperature problem and allows reactions with hydrides at sub-freezing temperatures, approaching −40° C. Also, controllability of these reactions is generally more feasible than in the case of hydrolysis, with less exothermic processes related to generally smaller heat of the alcoholysis reaction. However, in a similar way as the hydrolysis reactions, various hydrides behave differently in reactions with different alcohols, and adaptability of the reaction kinetics to a practical hydrogen generation system is a very important factor.

In parallel to the above problems of efficiency and controllability of the reactions of hydrogen generation, one practical issue (applicable to all these types of reactions) has to be solved before a viable chemical storage system can be developed. This problem is related to the efficient method of providing of controlled quantities of the liquid reagent (such as water or alcohol) to the main reagent (i.e. to the metal or hydride) in such a way that the reaction is effective, controllable and self-adjusting.

Various methods of hydrogen generation which were developed over the years intended to address the dosing problems of the liquid reagents. These approaches relied on various types of devices introducing water into the hydride vessel, such as injectors set forth in U.S. Pat. No. 6,866,836, issued to Jorgensen, Mar. 15, 2005, stirring mechanisms set forth in U.S. Pat. No. 5,372,617, issued to Kerrebrock et al., Dec. 13, 1994 (to distribute the water to unreacted hydride) or a water-selective membrane bringing water in contact with the hydride set forth in United States Publication No. US20030228252A1, Shurtleff, Dec. 11, 2003. For example, U.S. Pat. Nos. 5,728,464, issued to Checketts, Mar. 17, 1998 and 5,817,157, issued to Checketts, Oct. 6, 1998 teach a method of immersing sodium hydride pellets in water in such a way that NaH is encapsulated in plastic containers, which are physically open (cut) when hydrogen release is needed. Once open, the whole portion of NaH has to be consumed, because the reaction cannot be otherwise controlled. In another technology, a stable solution of sodium borohydride in water is pumped into a system compartment where it becomes contacted with a catalyst which causes hydrogen release as set forth in WIPO Publication No. 2004/018352, Mohring et al., filed Jul. 2, 2003, or U.S. Pat. No. 6,946,104, issued to Rusta-Sallehy et al., Sep. 20, 2005 and U.S. Pat. No. 6,737,184, issued to Rusta-Sallehy et al., May 18, 2004. In this case however, a significant overload of water is used, which is required for the solution to remain fluid and pumpable. The drawback of this method is that the system has to be fully loaded with water (usually a significant excess of water is needed for the reaction to proceed and to get a pumpable solution), thus making it heavy and difficult to manage. United States Publication No. US20040067195, Strizki et al., Apr. 8, 2004, describes system regulating rate of hydrogen generation by relative movement between fuel tank and the catalyst chamber. In U.S. Pat. No. 5,514,353, issued to Adlhart, May 7, 1996, water is wicked through the microporous membrane into the hydride cartridge generating hydrogen.

All these solutions rely on various types of dosing instrumentation, which significantly add weight and complexity to the hydrogen generation systems, and thus drastically reduce the overall hydrogen capacity, but still without sufficient controllability of the reaction kinetics and without adequate efficiency of the hydrogen generation.

In the present invention, instead of developing improved solutions for the hydrogen generation through mechanical designs of the reactors and systems, a fundamentally different approach was developed. This new approach relies on a specifically designed composition of matter providing unique combination of properties, which allow practical generation of hydrogen for various types of applications, including fuel cell technology.

The composition of matter according to one embodiment of the invention provides a functional combination of the ability to uptake a reagent form the environment through sorption mechanisms, combined with the capability to efficiently generate hydrogen in a reaction with the absorbed reagent.

The invention addresses the deficiencies of the conventional solutions of the chemical storage technologies by solving the problem of the reagent dosing through a self-adjusting sorption phenomenon, combined with the maximized efficiency of the hydrogen generation reaction achieved from an optimized, specifically designed composition of matter.

In a particular example of the moisture sorption used for hydrolysis reaction with hydrides, the present approach seems to be extremely advantageous in combination with a fuel cell device, where moist environment is directly available from the outlet of the fuel cell. On the other hand, the output of the hydrolysis is in this case moist hydrogen, which does not require additional humidification before entering the fuel cell system, being a common constraint of the conventional system arrangements.

### SUMMARY OF THE INVENTION

One object of the invention is to provide an improved hydrogen generation system.

A further object of one embodiment of the present invention is to provide a hydrogen generating composition, capable of liberating hydrogen through a sorption mechanism in the presence of vapour or gas of a reagent, comprising a sorbent compound for sorption of the vapour or gas of the reagent and a hydrogen-releasing agent for liberating hydrogen from the reagent retained by the sorbent compound.

According to the invention, hydrogen is released through reactions involving a specifically designed composition of matter, capable of using sorption mechanisms to supply a reagent for the hydrogen generation, for example water for hydrolysis. The composition is capable of generating hydrogen by comprising two functional components: a sorbent (which absorbs a reagent from the environment through a hygroscopic/deliquescent mechanism) and a hydrogen-releasing agent that generates hydrogen through a reaction with the reagent supplied by the sorbent.

The invention also provides a method for hydrogen generation from the above composition of matter through reactions involving sorption mechanisms, producing hydrogen as the reaction product.

Another object of one embodiment of the present invention is to provide a method of generating hydrogen through a sorption mechanism in the presence of vapour or gas of a reagent, comprising, providing a composition containing a sorbent for sorption of the reagent, a hydrogen-releasing agent for liberating hydrogen from at least one of sorbed reagent and the composition, contacting the composition with a source of the reagent to effect uptake of the reagent by the sorbent and conducting a reaction between sorbed reagent and the hydrogen-releasing agent to liberate hydrogen.

Having thus generally described the invention, reference will now be made to the accompanying drawings.

### BRIEF DESCRIPTION OF THE DRAWINGS

FIG. 1a is a photograph of non-catalyzed sodium borohydride powder exposed to humid air;

FIG. 1b is a photograph of non-catalyzed sodium borohydride after prolonged exposure;

FIG. 2a is a photograph of catalyzed sodium borohydride powder exposed to humid air;

FIG. 2b is a photograph of catalyzed sodium borohydride powder after prolonged exposure;

FIG. 3 is a graphical representation of moisture uptake as a function of time by the commercial powder of sodium borohydride and catalyzed sodium borohydride after exposure to air at relative humidity of 50%;

FIG. 4 is a series of x-ray diffraction patterns showing complete decomposition of the catalyzed NaBH₄ during the sorption-induced hydrolysis;

FIG. 5 is a photograph of catalyzed lithium borohydride after exposure to air at a relative humidity of 50%;

FIG. 6 is a graphical representation illustrating a comparison of the moisture uptake of the catalyzed lithium borohydride and the catalyzed sodium borohydride in argon at the relative humidity of 50%;

FIG. 7 is a histogram representation of the potential hydrogen capacities generated from various types of catalyzed hydrides and their combinations in sorption-induced hydrolysis reactions (water weight is not taken into account and hydrogen contribution from water is included);

FIG. 8a is a photograph of the catalyzed mixture of lithium borohydride and magnesium hydride exposed to humid air and the same powder after prolonged exposure;

FIG. 9 is a graphical representation of moisture uptake as a function of time by various mixtures of the catalyzed sodium borohydride and magnesium hydride;

FIGS. 10a and 10b are photographs of hydrolyzing mixtures of the catalyzed sodium borohydride and magnesium hydride exposed to air at relative humidity of 50%;

FIG. 11 is a graphical representation illustrating X-ray diffraction patterns of a catalyzed mixture of sodium borohydride and magnesium hydride before and after the moisture-induced hydrolysis;

FIG. 12 is a graphical representation of moisture uptake as a function of time by a mixture of sodium hydride and magnesium;

FIG. 13 is a graphical representation illustrating a comparison of the moisture uptake in argon of the commercial sodium borohydride and catalyzed sodium borohydride;

FIG. 14 is a graphical representation of moisture uptake as a function of time for catalyzed sodium borohydride NaBH₄ to absorb water at various levels of relative humidity;

FIG. 15 is a graphical representation of moisture uptake as a function of time of the catalyzed mixture of sodium borohydride and magnesium hydride in argon at various levels of relative humidity;

FIG. 16 is a graphical representation of moisture uptake as a function of time for the catalyzed mixture of lithium borohydride and magnesium hydride in argon at various levels of relative humidity; and

FIG. 17 is a graphical illustration of moisture uptake as a function of time for a catalyzed mixture of lithium borohydride and magnesium hydride in air, demonstrating controllability of the reaction through changing the relative humidity in the environment (applying a flow of dry argon to cease the moisture uptake).

### DETAILED DESCRIPTION OF THE PREFERRED EMBODIMENT

According to the invention, a controllable, practical generation of hydrogen can be realized by using compositions of matter with exceptional properties, which combine reagent sorption behaviour with the ability to generate hydrogen through reactions with the adsorbed reagent. The concept involves a specifically designed material composition, capable of using sorption mechanism to supply water for hydrolysis and at the same time able to decompose through hydrolysis with the release of hydrogen. An important aspect of the invention does not rely on the sorption mechanism alone or on the hydrogen generation reactions as such, but on a synergetic and optimized combination of these two functions in the chemical storage composition of the invention.

The hydrogen generation composition consists therefore of two functional components: a sorbent (with sufficient sorption ability to adsorb the reagent through sorption phenomena from the environment) and a hydrolyzing agent that releases hydrogen through a reaction with the absorbed reagent. These two components are “functional”, which means that it is necessary that they perform these two functions within the hydrogen generating system, but they do not necessarily have to represent two physically distinguishable species in the composition. In certain specific examples of the composition of the invention (as described below) both these functions can be performed by a single material, which is specifically engineered to be an effective hydrogen source.

The basic mechanism to supply the reagent to the hydrogen generating composition is the sorption phenomenon, which is to provide physical contact between the main reacting component (a hydride, metal etc.) and the reagent (water, alcohol, ammonia, CH₄, etc.) for the reaction to proceed. It is assumed that the reagent exists in the form of a vapour or gas in the environment around the reaction bed and the sorbent's role is to bring it into the physical contact with the main reagent in such quantities that are sufficient for the subsequent reaction of hydrogen generation. The sorbent should therefore exhibit excellent sorption properties, adequate for the desired reaction kinetics. Depending on the type of the hydrogen generation reaction, the reagent could be water, alcohol, ammonia etc, and the sorbent needs to have the specific sorption ability for this type of the reagent. For example, in the case of the hydrolysis reaction, sorption mechanisms should result in a significant water uptake form the humid environment, in amounts at least equal to the stoichiometric amount of water needed for the hydrolysis reaction. Such behaviour can be achieved by various types of desiccants and deliquescent or hygroscopic materials. “Deliquescent materials” are defined as solids capable of absorbing large amounts of water and forming a liquid solution with it. Typical examples of deliquescent material suitable for the invention are certain inorganic salts such as aluminates, calcium chloride, zinc chloride, lithium chloride, sodium acetate, potassium acetate and certain organic salts such as trimethylamine n-oxide. The deliquescent material (the sorbent component) is preferably in physical contact with the main reagent of the hydrolysis reaction, such as a hydride or metal. In this way, the adsorbed water can be easily transferred to the hydride and react with it. The hydrogen-generating composition can be optimized by applying the most efficient combinations of the deliquescent materials with the hydrolyzing components, depending on the required hydrogen flow or maximum capacity. For relatively fast and efficient reactions, a suitable composition comprises a mixture of calcium chloride as the sorbent and of alkali metal hydrides, such as for example sodium hydride or sodium alanate NaAlH₄, or lithium alanate LiAlH₄, or other hydrides that easily react with water. In such compositions, the ratio of the relative amounts of the sorbent and of the hydride needs to be determined, depending on the relative humidity of the environment and on other parameters of the reaction (such as heat transfer). In high-humidity environments, the amount of the deliquescent material can be reduced, because the hygroscopic nature of for example sodium hydride itself can be sufficient to undertake the function of the sorbent. In drier environments, the presence of the highly deliquescent component such as calcium chloride is needed in larger amount, in order to ensure sufficient supply of moisture to generate hydrogen.

The hydrogen generating system can be designed and engineered as an optimized, multi-component composition, depending on the reaction specifics. The sorbent should be active towards a specific reagent, such as water or alcohol, but alternatively the sorbent could be able to absorb both water and alcohol, if a mixture of water and alcohol is desired for the reaction. In another variation, a mixture of two sorbents could be used, one active towards water and the other towards alcohol. Similarly, the main reagent could be a single hydride or metal, or a multi-component mixture of hydrides and/or metals. Some of the sorbents could also generate hydrogen, and some of the main components may act as sorbents, according to the above definition of the “functional composition” for the hydrogen generation.

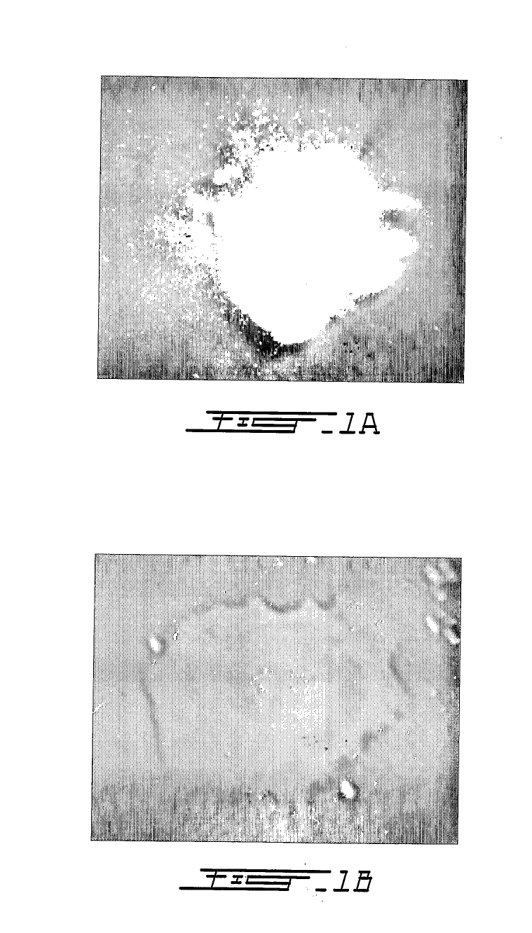

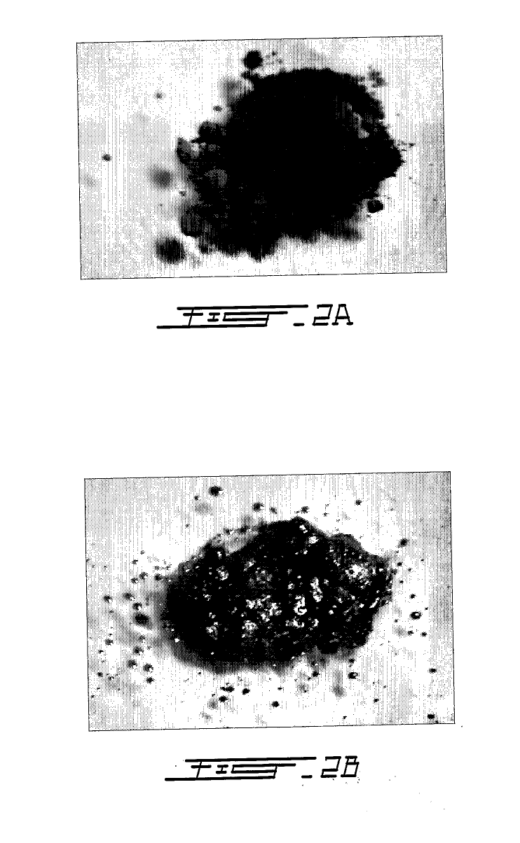

One remarkable fact is that certain hydrides with potentially very high hydrogen capacity (such as lithium borohydride, LiBH₄ or sodium borohydride, NaBH₄) can exhibit outstanding deliquescent properties by themselves. After exposure to humid air these hydrides are able to absorb significant amounts of water, forming a liquid solution, as shown in FIG. 1 for sodium borohydride. However, being potentially such excellent sorbents, they do not react noticeably with water and do not undergo hydrolysis.

The inert behaviour of many hydrides towards hydrolysis can be radically changed by catalysis. In general, catalysis can be a very efficient method of controlling the reaction of hydrogen generation in various types of reactions. Various catalysts have been used previously to catalyze hydrolysis reaction of such hydrides as sodium borohydride NaBH₄ (Y. Kojima et al., Journal of Power Sources 135 (2004) 36, Chuan Wu et al., Catalysis Today 93-95 (2004) 477-483, P. Krishnan et al, Journal of Power Sources 143 (2005) 17-23). It has been also demonstrated that a rhodium-based catalyst can be very efficient for the hydrolysis of NaBH₄ (Steven C. Amendola et al., Journal of Power Sources 85 (200) 186-189).

In the previous work, new catalytic complexes have been discovered which have shown outstanding capability of catalyzing various reactions of hydrogen transfer and hydrogen generation. These new catalytic compositions are described in the article by A. Zaluska and L. Zaluski “New catalytic complexes for metal hydride complexes”, Journal of Compounds and Alloys 404-406 (2005) 706 and in United States Publication No. 20050002856, Zaluska et al., Jan. 6, 2005 Extraordinary improvement of the reaction kinetics can be obtained by using this new type of catalyst based on specific molecular compositions involving hydrogen, a metal component and an electronegative component. Many hydrides normally inert in water, such as sodium borohydride (NaBH₄) and magnesium hydride (MgH₂), become very active in the presence of the new type of the catalyst, while without the catalytic enhancement they do not exhibit any significant reaction.

A remarkable finding of the present invention is that a combination of the sorption mechanism with catalysis enabling hydrogen generation gives outstanding performance during hydrolysis induced by the moisture uptake, with even better deliquescent properties than that of the non-catalyzed hydrides. These compositions represent therefore a new, unique chemical storage solution, with higher practical hydrogen capacities than any previous hydrogen generation system, in combination with controllable and self-adjusting reagent dosing solution.

The conclusion of all experiments was to determine that the catalytic ability of the new type of the catalytic complexes does not deteriorate or disappear after exposure to air and, in particular, to humidity. In contrast to the common behaviour of catalysts with extreme activity (which get poisoned immediately when exposed to air) our catalyst remained active for hydrolysis even after prolonged exposures.

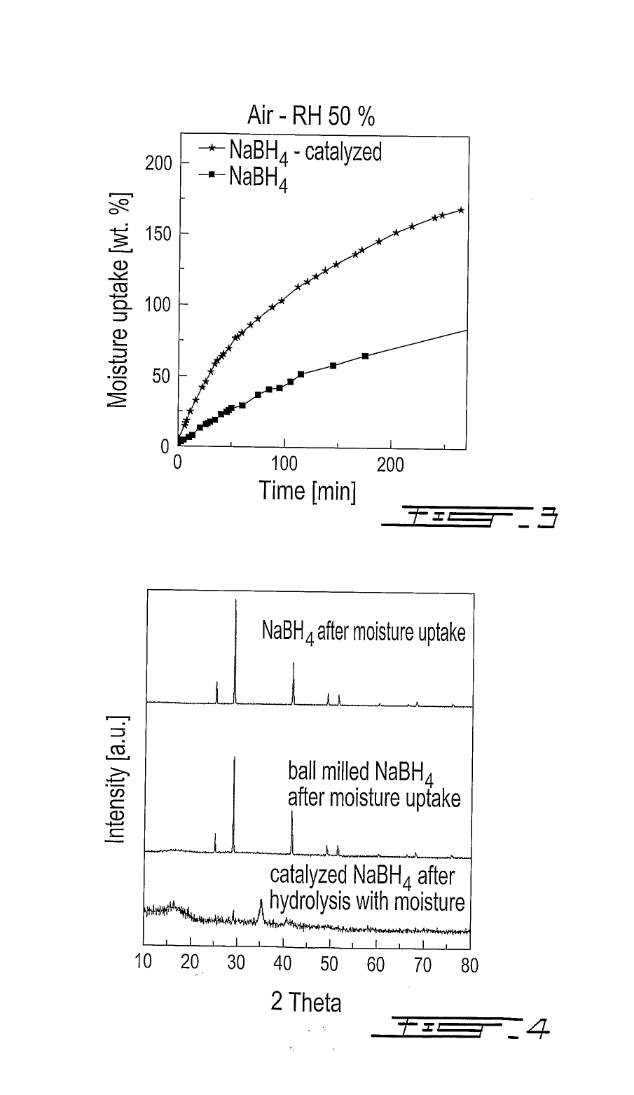

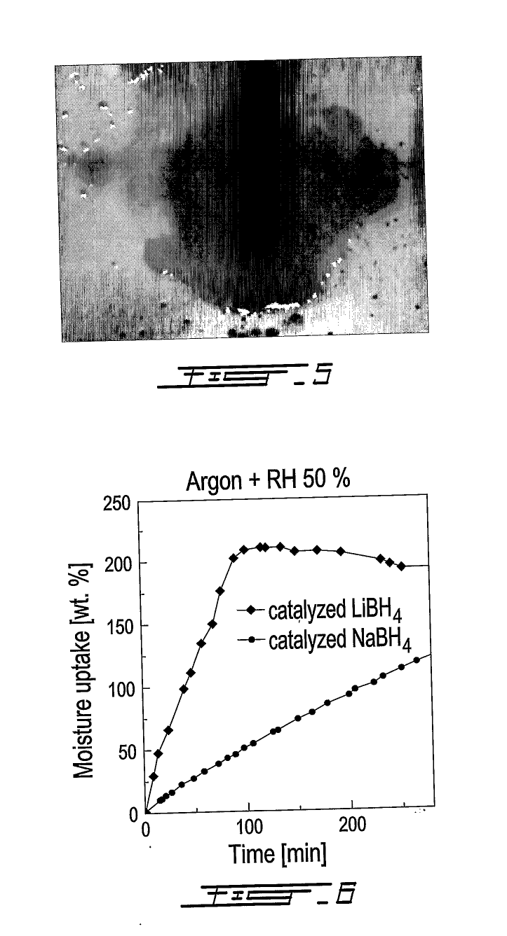

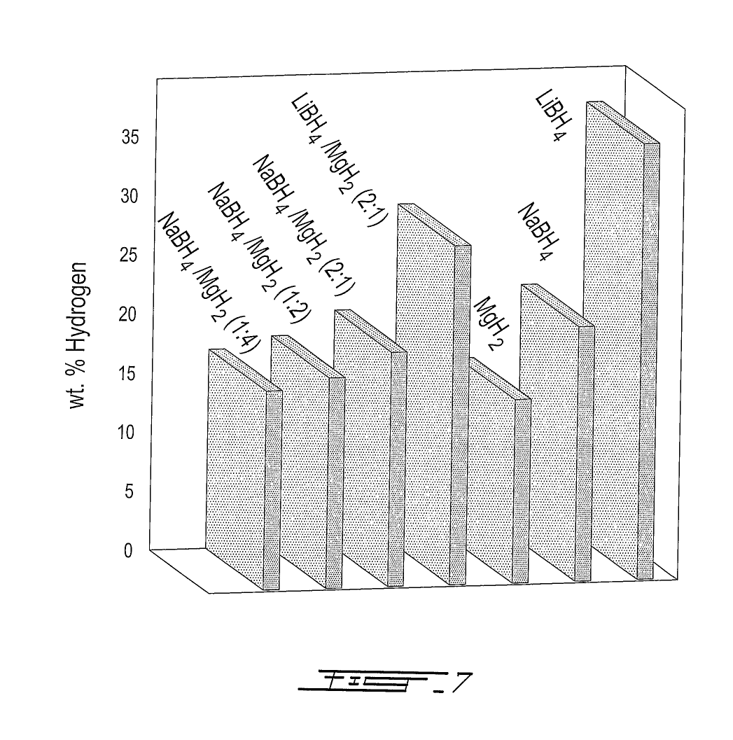

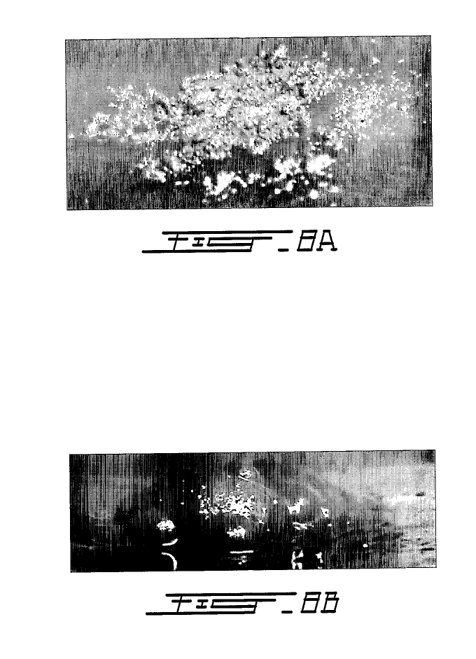

As seen in FIGS. 1a and 1b, sodium borohydride is highly deliquescent, but the solution is stable without any visible reaction. FIG. 1a shows NaBH₄ powder exposed to air at the relative humidity of 50%, which spontaneously transforms into a liquid solution after prolonged exposure FIG. 1b. This behaviour changes drastically when the sodium borohydride powder contains an addition of the catalyst of the new type, prepared according to United States Publication No. 20050002856. The catalyzed material not only exhibits better hygroscopic properties than the non-catalyzed NaBH₄, but also decomposes instantly with substantial release of hydrogen, as shown in FIGS. 2 and 3. Generation of hydrogen as seen in FIG. 2 is a continuous process which was confirmed by using the hydrogen sensor SENSISTOR™ H2000 and also by x-ray diffraction of the material after the hydrogen uptake and hydrolysis. As shown in FIG. 4, complete decomposition of the catalyzed NaBH₄ during the sorption-induced hydrolysis was achieved. This hydrogen-generating material exemplifies an aspect of the invention, wherein a specific composition, two functional components (i.e. the sorbent and the hydrolyzing agent) are combined in one, due to the extraordinary properties of the catalyzed hydride. This specific composition is able to both absorb moisture from air and to decompose in the reaction with the absorbed water, generating a significant amount of hydrogen. Catalyzed lithium borohydride (LiBH₄) is another example of the hydrogen generation system according to the invention, as seen in FIGS. 5 and 6. Catalyzed lithium borohydride has much higher hydrogen capacity generated in the hydrolysis than sodium borohydride, and also exhibits even better deliquescent properties than NaBH₄ (FIG. 6). Actually, lithium borohydride represents the highest hydrogen capacity potentially achievable in the hydrolysis reactions amongst all known hydrides, however normally unusable. When the hydrolysis reaction is adequately catalyzed and in combination with the efficient sorption mechanism, lithium borohydride becomes hydrogen carrier with unsurpassed capacity. As shown in the diagram in FIG. 7, LiBH₄ can potentially provide more than one third of its weight of hydrogen to be released in the reaction with water. This is calculated without taking into account the weight of water, which is to contribute to the total amount of available hydrogen in the hydrolysis reaction. In other words, the diagram shows potential hydrogen capacities for hydrides being carried without water, while water is to be added from the environment by the spontaneous sorption mechanisms. When water is included in the system weight, lithium borohydride still represents the record hydrogen capacity of all known hydrides in chemical storage technologies, i.e. 13.9 wt. %.

FIG. 6 illustrates another important aspect of the invention, which is the ability of the sorption process to self-adjust. As a result of the overlapping effects of the moisture uptake and the weight loss due to the hydrogen generation, after prolonged hydrolysis of lithium borohydride the hydrogen release becomes predominant, resulting in the relative weight loss seen in FIG. 6. This phenomenon is an exemplification of the self-adjusting rate of sorption, where the water uptake decreases with the advancing hydrolysis. This phenomenon has however a slightly different character in the case of the catalyzed sodium borohydride, where the hydrolysis products are able to sustain the sorption due to their own deliquescent properties, and thus no apparent weight loss is seen in the moisture uptake curves because of the hydrogen generation. These features are related to specific properties of each particular component of the hydrogen generation composition and therefore they represent a practical tool in the design of the optimum composition of the invention. Depending on particular needs of an application, an optimized combination of various features of the hydrogen generation can be achieved, taking into account the rate of moisture sorption, the rate of hydrogen generation, kinetic profile of the reaction, maximized amount of the generated hydrogen, cost of the composition, availability of the components. One example of such optimized composition is a mixture of catalyzed powders of lithium borohydride and sodium borohydride, where LiBH₄ provides faster water sorption at the initial phase of the process, and NaBH₄ is able to provide better deliquescence in the final stage.

Another way to optimize the hydrogen-generating composition is to use such hydrides as above (alone or as mixtures) to provide moisture not only for their own decomposition, but also to other components which are not capable of sufficient deliquescence and moisture uptake. An example of such hydrolyzing agents with insufficient hygroscopic properties is the catalyzed magnesium hydride, which becomes an excellent hydrogen source when combined with a more efficient sorbent. Magnesium hydride exhibits very good hydrogen generation rates with such sorbents as calcium chloride and other deliquescent salts, but even more advantageous is its combination with the catalyzed deliquescent hydrides. In such compositions, the deliquescent abilities of these hydrides are not only adequate for their own hydrolysis, but they are also capable of absorbing excessive amounts of moisture, enough for the additional hydrolysis of the less hygroscopic, catalyzed MgH₂. Such hydride as lithium borohydride, sodium borohydride or sodium hydride can act therefore not only as sorbents and reagents, but also simultaneously as sorbents for the other hydrolyzing components. A series of compositions with various mixtures of this type was fabricated and tested, showing indeed that the sorption-induced hydrolysis can be optimized in relation to the reaction rate, hydrogen capacity, and very importantly—the cost of the hydride material. Such optimization can be done by changing the type and amount of the deliquescent hydride versus the hydrolyzing agent. FIG. 8 shows a catalyzed mixture of lithium borohydride and magnesium hydride exposed to humid air and the same after prolonged exposure resulting in significant water uptake and hydrogen generation.

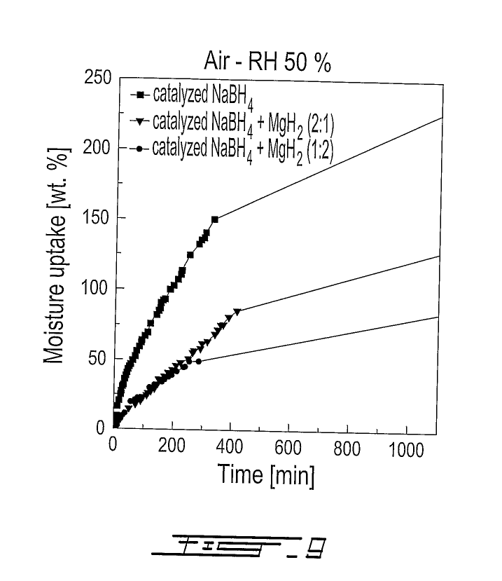

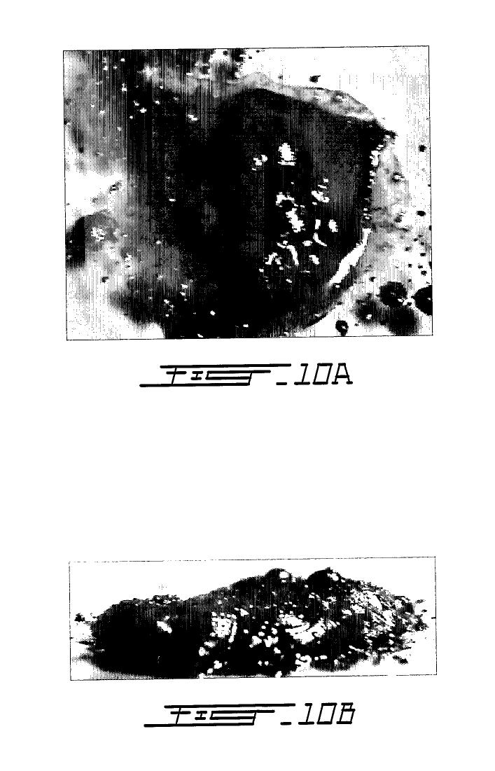

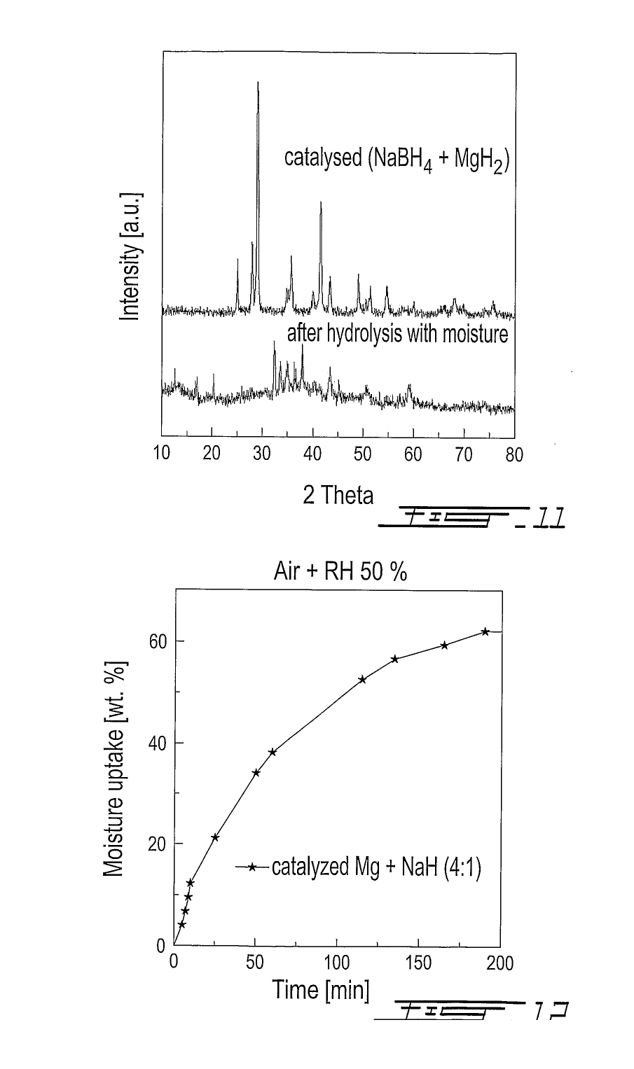

As shown in FIG. 9 for a catalyzed mixture of NaBH₄ and MgH₂, the sorption rate can be reduced by increasing the content of magnesium hydride as compared to the NaBH₄ alone, but hydrogen generation is still preserved because of the additional reaction with the catalyzed magnesium hydride, as shown in FIG. 10. After continued hydrolysis induced by moisture sorption, the dried reaction products were analyzed by x-ray diffraction, as shown in FIG. 11. The patterns demonstrated full hydrolytic transformation of the catalyzed sodium borohydride, as well as of the catalyzed magnesium hydride, while leaving no unreacted residues of the initial hydrides other than the hydrolysis products.

Further variations of the composition according to the invention can be done by using metals as hydrolyzing agents, such as magnesium, aluminum etc. Example of such composition is shown in FIG. 12, presenting water uptake by a hydrolyzing mixture of sodium hydride and magnesium.

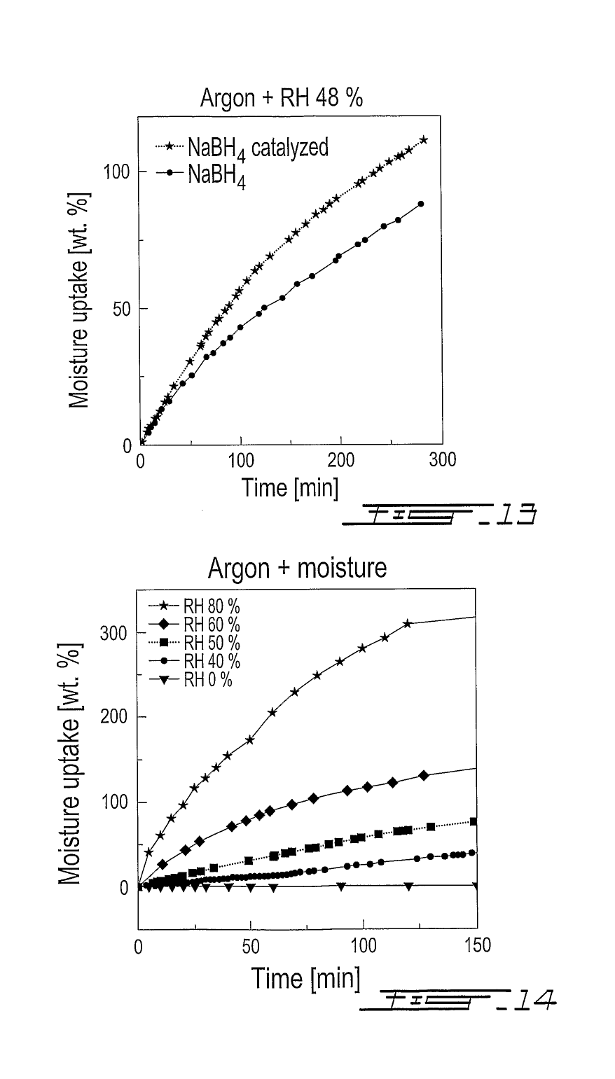

Another aspect of the invention is the capability of the materials to generate hydrogen from moisture in various types of environment—not only humid air, but also inert gases such as argon or nitrogen, or even vacuum. The results showed that the sorption mechanisms are effective when inert gases or vacuum carry the moisture to be absorbed by the hydrolyzing material. Similar to the moist air, humid argon can also effectively supply water to the sorption-induced hydrolysis; in this case the catalyzed systems are more active towards sorption than the non-catalyzed compositions, as shown in FIG. 13 for sodium borohydride.

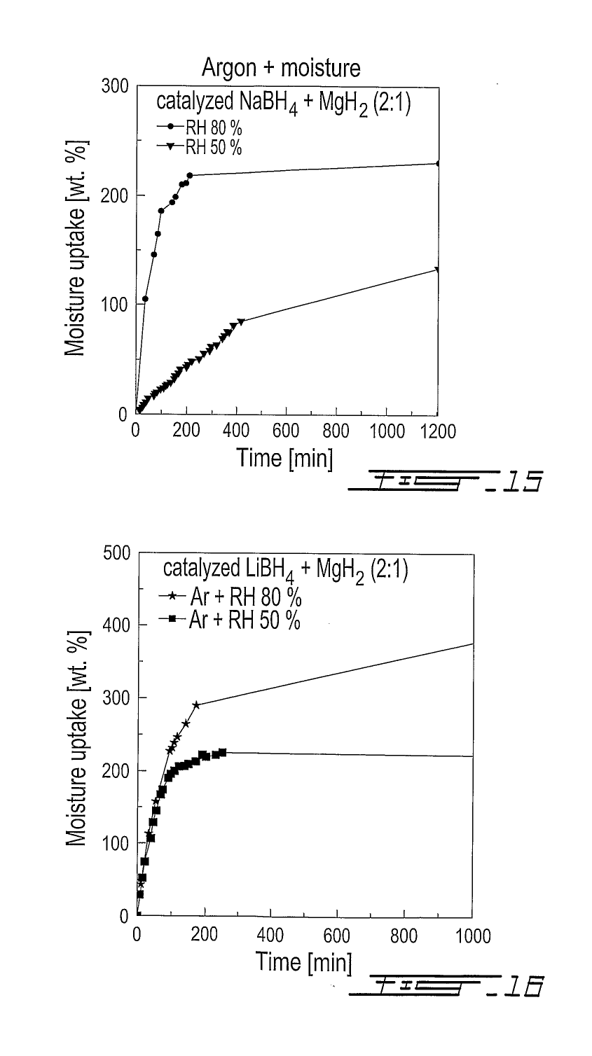

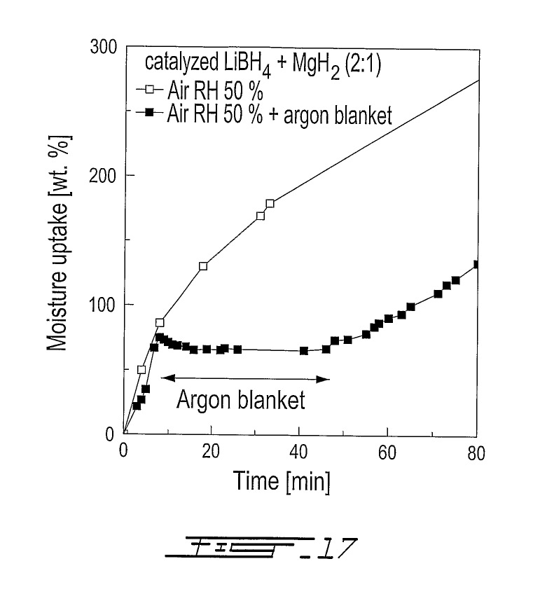

A particularly beneficial feature of the invention which gives unprecedented advantage over previous chemical storage systems, is controllability of the process of hydrogen generation through adjustments of the humidity in the environment. The rate of moisture absorption depends directly on the relative humidity maintained in argon or air and thus the humidity level can be used as an effective tool in controlling the rate of the hydrogen generation, as shown in FIG. 14 for the catalyzed sodium borohydride, in FIG. 15 for the catalyzed mixture of sodium borohydride with magnesium hydride and in FIG. 16 for the catalyzed mixture of lithium borohydride with magnesium hydride. It is interesting to note that for this last composition, a stabilization of the weight changes was attained for the relative argon humidity of 50%, indicating that a right balance was achieved between the rates of the moisture sorption causing the weight increase with the hydrogen generation resulting in the weight loss. This experiment illustrates the principles of the balanced design of the composition according to the invention depending on the needs of the application device.

In another experiment, it was demonstrated that the control of the hydrogen generation system can be also achieved by dynamically changing the humidity of the environment, thus providing another means for the self-adjusting control of the sorption-induced hydrogen generation. As shown in FIG. 17, moisture sorption (and thus hydrolysis) can be slowed down and even ceased by simply applying a flow of dry gas in the environment.

It has been demonstrated on many examples that natural sorption can be a very efficient and controllable technique for supplying reagents to the reactions of hydrogen generation.

The rate of the hydrogen generation is related to various experimental conditions, especially the type and relative contents of the sorbent and of the hydrolyzing agent, catalysis of the reaction, relative humidity and the type of the moisture carrier. All these factors combined together represent useful tools in the design and optimization of the hydrogen generation system based on the sorption mechanisms. Mixtures of hydrides allow advantageous combinations of properties, such as optimized deliquescent ability combined with maximized amount of the generated hydrogen.

Chemical storage using sorption-induced reactions exhibits significant advantages over the conventional solutions, in particular—very high efficiency and controllability of the hydrogen generation. The most important potential advantage of such solution is to integrate the hydride arrangement with the fuel cell system. Moisture can be directly available from the fuel cell output and the direct production of moist hydrogen eliminates the need for additional humidification. Natural sorption mechanisms allow exceptional miniaturization of the chemical storage device, with the additional elimination of the water dosing devices, such as pumps and regulators.

Incorporation of sorption mechanisms in the catalyzed hydrolysis gives therefore controllable and integrated hydrogen generation allowing system miniaturization and high efficiency of hydrogen generation.

Having described the invention, reference will now be made to the examples.

### EXAMPLES

### Example 1

A hydrogen generating composition according to the invention was prepared by using sodium borohydride (NaBH₄). Three samples were prepared to demonstrate advantages of the invention: one was made of the commercial NaBH₄ powder without any treatment, and two other samples were ball milled—one of them was catalyzed and one of them was not.

For the ball milled sample, the starting material (1 g, from Alfa-Aesar with the purity of 98%) was loaded into the stainless steel vial of a ball mill together with stainless steel balls, giving a ball-to-powder ratio of about 16:1. The handling and loading of the materials was done in a glove box under high-purity atmosphere of argon (with less than 1 ppm of oxygen and 1 ppm water impurities). Ball milling was performed for 4 hours. The catalyzed sample was prepared in the same way, but an additional ball milling was performed afterwards (1 h) with an addition of 100 mg of a catalyst. The titanium-based catalyst was prepared according to the teachings of United States Publication No. 20050002856. The catalyst was produced from titanium hydride TiH₂ and copper Cu, in a process of ball milling with methanol. 6 g of titanium hydride TiH₂ (Aldrich, purity 98%, powder −325 mesh) was placed in a stainless steel vial with 4 g of copper Cu (Johnson Matthey, purity 99.5%) and 3 ml of methanol (methyl alcohol HPLC grade 99.9%), together with stainless steel balls, giving a ball-to-powder ratio of 6.4:1. The loading was done in a glove box with protective argon atmosphere. Ball milling was performed for 9 hours. After the process, there was no visual presence of the liquid phase, and the product was a black, fine powder. This catalyst was used to prepare the composition of the catalyzed sodium borohydride, as described above.

After preparation, each of the samples was exposed to air at relative humidity of 50% and positioned on a precision balance under a fume hood. The weight changes of the samples were recorded over time, along with the observations of the sample appearance. All three samples started to absorb moisture and to gain weight immediately after exposure to humid air. As shown in FIG. 1, the sample without any treatment became moist and subsequently liquid as a result of the water absorption. After prolonged exposure, the powder fully dissolved in the absorbed water, however without any visible decomposition or hydrogen generation. A comparative sample which was ball milled without the catalyst, absorbed moisture faster than the commercial powder, because of the finer granularity of the powder which resulted in higher (and also probably more active) specific surface available for the moisture adsorption. This sample exhibited however similar behaviour as the commercial powder in relation to hydrolysis—the powder dissolved in the absorbed water without any visible hydrogen generation. The catalyzed sample behaved differently. The absorption of moisture was even faster than that of the ball milled sample without the catalyst. Moreover, instead of dissolving in water, the composition immediately started to produce bubbles of gas which was tested by using the hydrogen sensor SENSISTOR™ H2000 to be hydrogen. The process of generating hydrogen as seen in FIG. 2 and the consequent weight loss resulting from the release of hydrogen was overlapping with the simultaneous weight gain from the water uptake. The overall weight increase of the sample was however predominant, as shown in FIG. 3, demonstrating outstanding sorption properties of this composition. The hydrogen generation continued for a prolonged period of time. The composition remained wet even when no more hydrogen bubbles could be seen. After drying the samples by heating them to 60° C. in a vacuum drier, the hydrolysis products were characterized by x-ray diffraction using a Bruker D8 Discover™ x-ray diffraction system. Crystallographic structures of the dried samples after exposures to the water uptake are compared in FIG. 4. Both the commercial powder and the ball milled powder did not show any signs of decomposition after being exposed to humid air and dissolved in the absorbed water (as in FIG. 1). By contrast, x-ray diffraction pattern of the catalyzed powder after moisture-induced hydrolysis was different as shown in FIG. 4. The crystallographic structure of the sodium borohydride was not seen any more, indicating full transformation of NaBH₄ as a result of the reaction with the absorbed water.

### Example 2

A lithium-containing composition according to the invention was prepared using commercial lithium borohydride LiBH₄. The LiBH₄ powder was purchased from Aldrich with the purity of 95%. All experimental conditions were in this case similar to the sodium borohydride experiments of Example 1. The starting lithium borohydride (900 mg) was loaded into the stainless steel vial of a ball mill together with 90 mg of a catalyst prepared according to the procedure described in Example 1. Stainless steel balls were also placed into the vial, giving a ball-to-powder ratio of about 16:1. The handling and loading of the materials was done in a glove box under high-purity atmosphere of argon (with less than 1 ppm of oxygen and 1 ppm water impurities). Ball milling was performed for 1 hour. In a similar way as above, moisture uptake was measured in comparative samples: commercial LiBH₄, LiBH₄ ball milled without the catalyst and a sample with the catalyst. The samples showed analogous behaviour to the sodium borohydride. Despite their excellent deliquescent properties, both samples of the commercial and non-catalyzed samples did not exhibit hydrolysis with the absorbed water. However, the catalyzed sample had not only outstanding sorption properties, but also showed very efficient generation of hydrogen. Also, lithium borohydride demonstrated much better ability to absorb moisture than sodium borohydride, as shown in FIGS. 5 and 6. It exhibited much faster weight gain than NaBH₄, and also had much more “liquid-like” appearance shortly after the exposure, as shown in FIG. 5, being subsequently followed by gaseous hydrogen generation.

### Example 3

Another hydrogen generating composition according to the invention was prepared, which consisted of a mixture of the deliquescent material and a hydrolyzing agent. Calcium chloride, CaCl₂, was used as the sorbent, which was purchased from Alfa Aesar with the purity of 96%) The catalyzed magnesium hydride was used as the hydrolyzing component.

To produce catalyzed magnesium hydride, pure magnesium was purchased from Alfa Aesar, with 99.8% purity. Magnesium powder was mixed with 10 wt. % of the catalyst (prepared from TiH₂ and Cu as described in Example 1) and ball milled for a short period of time (less than 1 hour) in order to provide good distribution of the catalyst over magnesium powder.

Hydrogenation of the catalyzed magnesium was performed in the automated, computer controlled gas titration system, which allows precise evaluation of hydrogen uptake and release by measuring pressure changes in a closed system.

In contrast to the conventional magnesium which requires high-temperature activation, catalyzed magnesium powder exhibited fast formation of magnesium hydride at room temperature, without any activation or preheating. After hydrogenation, the material exhibited x-ray diffraction pattern characteristic for MgH₂.

Magnesium hydride prepared as above demonstrated excellent reactivity towards hydrolysis, as described in US 2005 0002856A1.

The powders of the catalyzed magnesium hydride (prepared as above) and calcium chloride were mixed together in the glove box under protective atmosphere of argon with less than 1 ppm of oxygen and 1 ppm of water. The mixture was subsequently exposed to air at the relative humidity of 50%. The deliquescent ability of the calcium chloride caused significant moisture sorption, which resulted in the weight gain of the sample, as well as in a visibly wet appearance. The moisture uptake was sufficient to provide enough water for the hydrolysis of the catalyzed magnesium, which generated hydrogen.

### Example 4

A composition of the catalyzed mixture of LiBH₄ and MgH₂ was prepared with the molar ratio of 2:1. Lithium borohydride was purchased from Aldrich with the purity of 95% and catalyzed magnesium hydride was prepared as described in Example 3. For a total of 1 g, 623 mg of lithium borohydride and 377 mg of the catalyzed magnesium hydride was loaded into the stainless steel vial of a ball mill together with stainless steel balls, giving a ball-to-powder ratio of about 16:1. The handling and loading of the materials was done in a glove box under high-purity atmosphere of argon (with less than 1 ppm of oxygen and 1 ppm water impurities). Ball milling was performed for 12 hours. Subsequently, the mixture was ball milled for an additional 1 hour with the addition of 10 wt % of the catalyst, which was prepared according to the US 2005 0002856A1. The catalyst was produced from titanium hydride TiH₂ and copper Cu, as in Example 1.

As shown in FIG. 8, the catalyzed mixture of lithium borohydride and magnesium hydride exhibits a significant hydrogen generation, which occurred after the exposure to humid air.

### Example 5

A series of hydrogen generating compositions consisting of the catalyzed mixtures of NaBH₄ and MgH₂ was prepared with molar ratios of 2:1, 1:1, 1:2 and 1:4. The mixtures of total 1 g of the respective amounts of sodium borohydride NaBH₄ (from Alfa-Aesar with the purity of 98%) and magnesium hydride MgH₂ (from Tego Mangan with the purity of 95%) were loaded into the stainless steel vial of a ball mill together with stainless steel balls, giving a ball-to-powder ratio of about 16:1. For example, the 2:1 mixture was prepared by loading 742 mg of sodium borohydride NaBH₄ and 258 mg of magnesium hydride MgH₂. The handling and loading of the materials was done in a glove box under high-purity atmosphere of argon (with less than 1 ppm of oxygen and 1 ppm water impurities). Ball milling was performed for 4 hours. Subsequently, the mixture was ball milled for an additional 1 hour with the addition of 88 mg of the catalyst, which was prepared as described in Example 1.

The series of the catalyzed mixtures of NaBH₄ and MgH₂ with different molar ratios was tested as in Example 1, in relation to the moisture uptake and hydrogen generation. The samples demonstrated excellent combination of the deliquescent properties and the hydrogen release ability. As shown in FIG. 9 the rate of moisture sorption was related to the amount of the sorbent component (NaBH4), being reduced with the increase of the content of magnesium hydride. At the same time, magnesium hydride was reacting with water supplied by the sodium borohydride and both hydrides were generating hydrogen in the hydrolysis reaction, as seen in FIG. 10. After the reactions were finished, the samples were dried by heating them to 60° C. in a vacuum drier and the hydrolysis products were characterized by x-ray diffraction using a Bruker D8 Discover™ x-ray diffraction system. As shown in FIG. 11, the x-ray patterns demonstrated full transformation of both the catalyzed sodium borohydride, as well as of the catalyzed magnesium hydride, without noticeable unreacted residues of the initial hydrides.

### Example 6

Another composition according to the invention was prepared, to combine sorption properties of one component (in this case sodium hydride) with another hydrolyzing component—magnesium. Magnesium was purchased from Alfa Aesar with 99.8% purity and sodium hydride NaH was purchased from Aldrich with 95% purity. A composition was prepared with molar ratio of Mg and NaH equal 4:1. 802 mg of Mg powder and 198 mg of NaH (total 1 g) was loaded into the stainless steel vial of a ball mill together with stainless steel balls, giving a ball-to-powder ratio of about 16:1. The handling and loading of the materials was done in a glove box under high-purity atmosphere of argon (with less than 1 ppm of oxygen and 1 ppm water impurities). Ball milling was performed for 4 hours. Subsequently, the mixture was ball milled for an additional 1 hour with the addition of 88 mg of the catalyst, which was prepared according to the process described in US 2005 0002856A1. To produce the catalyst, a commercial titanium hydride (TiH₂) was used as a starting material, which was purchased from Aldrich (purity 98%, powder −325 mesh). 10 g of titanium hydride was loaded into a stainless steel vial together with approximately 3 ml of methanol (methyl alcohol HPLC grade 99.9%) and stainless steel balls, giving a ball-to-powder ratio of about 5:1. The loading was done in a glove box with protective argon atmosphere (less than 1 ppm of oxygen and less than 1 ppm of water). Ball milling was performed for 9 hours. After the process, the material turned into deep-black, very fine powder, without visual presence of the liquid phase.

The catalyzed mixture was exposed to air at the relative humidity of 50%, which resulted in the moisture uptake (shown in FIG. 12), which was sufficient not only to decompose sodium hydride, but also the catalyzed magnesium hydride.

### Example 7

A series of samples of the composition prepared as in Example 1 was studied in experiments with different humidity levels. The experiments were performed inside a glove box, which was initially evacuated to remove air residues, then purged and filled with argon to ambient pressure. The desired humidity level was obtained by the controlled evaporation of water inside the glove box, while the humidity level was monitored. The experiments of moisture uptake were performed in the same way as in air, i.e. with measuring the weight gain and observations of the sample appearance. The results demonstrated that sorption mechanisms can be efficient when different moisture carriers are used—not only air, but also inert gases or vacuum. As seen in FIG. 13, moisture uptake in the catalyzed sample of sodium borohydride in argon is faster than the sorption of the non-catalyzed sample, similarly to moisture uptake in air. Also, the catalyzed sample undergoes hydrolysis with the production of hydrogen in the same way as in air, without any noticeable differences in the reaction products. There is however a general trend that the sorption rate is faster in air than in argon of all tested compositions.

FIG. 14 shows a summary of the moisture uptake rate of the sodium borohydride in dependence on the relative humidity level in argon. As expected, the higher humidity, the faster moisture uptake was observed, making this a convenient tool for adjusting the hydrogen generation rate.

### Example 8

A composition of the catalyzed mixture of NaBH₄ and MgH₂ was prepared as described in Example 5, with a molar ratio of 2:1. The catalyzed mixture of NaBH₄ and MgH₂ was tested in argon with different humidity levels. As shown in FIG. 15, such compositions are sensitive to the amount of moisture in argon, with faster sorption for higher humidity levels.

### Example 9

A composition of the catalyzed mixture of LiBH₄ and MgH₂ was prepared with the molar ratio of 2:1. Lithium borohydride was purchased from Aldrich with the purity of 95% and magnesium hydride MgH₂ was purchased from Tego Mangan with the purity of 95%. For a total of 1 g, 623 mg of lithium borohydride and 377 mg of magnesium hydride was loaded into the stainless steel vial of a ball mill together with stainless steel balls, giving a ball-to-powder ratio of about 16:1. The handling and loading of the materials was done in a glove box under high-purity atmosphere of argon (with less than 1 ppm of oxygen and 1 ppm water impurities). Ball milling was performed for 1 hour. Subsequently, the mixture was ball milled for an additional 1 hour with the addition of 10 wt % of the catalyst, which was prepared according to the US 2005 0002856A1. The titanium based catalyst was produced as described in Example 1.

The catalyzed mixture of LiBH₄ and MgH₂ was tested in argon with different humidity levels. As shown in FIG. 16, such compositions are sensitive to the amount of moisture in argon, so that both the sorption properties and the hydrolysis rate can be controlled.

### Example 10

This example illustrates the ability to dynamically control the sorption rate and thus the hydrogen generation rate by changing the humidity in the environment.

The composition according to the invention was prepared as described in Example 4. As shown in FIG. 17, this composition exhibited excellent hydrogen generation through moisture absorption when exposed to air at the relative humidity of 50%. A comparative sample was also exposed to air, but subsequently an “argon blanket” was used to slow down the moisture sorption, which was done by applying a flow of dry argon over the sample surface. The respond time was very fast and the sorption ceased immediately, while some weight loss was observed as a result of the hydrogen release from the already absorbed water. After removing the argon blanket, the sorption resumed with similar rate as previously. This experiment demonstrates the self-adjustment ability of the compositions according to the invention, which supports the possibility to control the sorption-induced hydrogen generation.

1. A hydrogen generating composition, capable of liberating hydrogen through a sorption mechanism in the presence of vapour or gas of a reagent, comprising:
a sorbent compound for sorption of said vapour or gas of said reagent; and
a hydrogen-releasing agent for liberating hydrogen from said reagent retained by said sorbent compound.

2. The composition as set forth in claim 1, wherein said sorbent is catalyzed.

3. The composition as set forth in claim 1, wherein said hydrogen releasing agent is catalyzed.

4. The composition as set forth in claim 1, wherein said reagent is capable of generating hydrogen in reaction with said hydrogen releasing agent.

5. The composition as set forth in claim 1, wherein said reagent is selected from the group consisting of water, alcohol, ammonia, organic vapour, methane, ethane, natural gas, hydrogen-containing vapour or gas, or a mixture of thereof.

6. The composition as set forth in claim 1, wherein said reagent is water.

7. The composition as set forth in claim 1, wherein said sorbent is a compound having deliquescent properties.

8. The composition as set forth in claim 1, wherein said sorbent is a compound having hygroscopic properties.

9. The composition as set forth in claim 1, wherein said sorbent comprises a deliquescent hydride.

10. The composition as set forth in claim 1, wherein said sorbent comprises a desiccant.

11. The composition as set forth in claim 1, wherein said sorbent comprises a deliquescent salt selected from the group consisting of aluminates, calcium chloride, zinc chloride, lithium chloride, sodium acetate, potassium acetate, trimethylamine n-oxide or mixtures thereof.

12. The composition as set forth in claim 1, wherein said hydrogen-releasing agent comprises a compound capable of producing hydrogen in a reaction with said reagent.

13. The composition as set forth in claim 1, wherein said hydrogen-releasing agent is a hydrolyzing agent capable of producing hydrogen in a reaction with water.

14. The composition as set forth in claim 1, wherein said hydrogen-releasing agent comprises a hydride.

15. The composition as set forth in claim 1, wherein said hydrogen-releasing agent comprises a metal.

16. The composition as set forth in claim 1, wherein said hydrogen-releasing agent comprises a combination of a hydride and a metal or a mixture of hydrides and metals.

17. The composition as set forth in claim 1, wherein said sorbent and said hydrogen releasing agent comprise the same compound.

18. A method of generating hydrogen through a sorption mechanism in the presence of vapour or gas of a reagent, comprising: providing a composition containing:
a sorbent for sorption of said reagent;
a hydrogen-releasing agent for liberating hydrogen from at least one of sorbed reagent and said composition;
contacting said composition with a source of said reagent to effect uptake of said reagent by said sorbent; and
conducting a reaction between sorbed reagent and said hydrogen-releasing agent to liberate hydrogen.

19. The method as set forth in claim 18, further including the step of controlling the rate of hydrogen liberation.

20. The method as set forth in claim 18, further including the step of varying the amount of said reagent exposed to said composition.

21. The method as set forth in claim 18, wherein said reagent is provided in a carrier medium.

22. The method as set forth in claim 21, wherein said carrier medium is selected from air, inert gas or vacuum.

23. The method as set forth in claim 18, further including the step of converting said sorbent from a substantially non-reactive sorbent to a hydrogen-releasing sorbent.

24. The method as set forth in claim 23, wherein conversion is effected by catalyzing said sorbent.

25. The method as set forth in claim 18, further including the step of combining at least two sorbents and at least two hydrogen releasing agents in said composition.

26. The method as set forth in claim 18, further including the steps of catalyzing said sorbent to function as a sorbent and hydrogen-releasing agent;
providing a second catalyzed hydrogen-releasing agent; and
reacting said second catalyzed hydrogen-releasing agent with said reagent from the catalyzed sorbent to liberate said hydrogen.
